(19) United States
(12) Patent Application Publication
(10) Pub. No.: US 2026/0206959 A1
(43) Pub. Date: Jul. 23, 2026

(54) Toothbrush With Integrated Floss Threading Feature

(71) Applicant: Matthew Joseph Lucciola, Union City, NJ (US)

(72) Inventor: Matthew Joseph Lucciola, Union City, NJ (US)

(21) Appl. No.: 19/450,567

(22) Filed: Jan. 15, 2026

Related U.S. Application Data
(60) Provisional application No. 63/745,685, filed on Jan. 15, 2025.

(51) Int. Cl. A46B 15/00; A61C 15/04; A61C 17/22

(52) U.S. Cl. CPC A46B 15/0073; A61C 15/045; A61C 17/225

(57) ABSTRACT

A toothbrush assembly, referred to as the Floss Tool, integrates a conventional toothbrush with a passive floss-threading structure that provides a single-point anchor for dental floss supplied from an external source. One end of the floss is received and retained at a single anchoring location on the toothbrush, while the opposing end is held manually by the user, so the floss is not stretched between spaced-apart support members and is not dispensed from any internal spool, cartridge, or tensioning mechanism. The floss-threading structure may be implemented as a hole, slit, or hook positioned on the handle or head of the toothbrush, enabling users to anchor floss while brushing to facilitate cleaning of interproximal regions. The toothbrush assembly can be incorporated into otherwise conventional manual or powered toothbrush platforms with minimal modification, reducing reliance on separate flossing tools and encouraging adherence to recommended oral hygiene practices.

### FIELD OF THE INVENTION

The present invention generally relates to oral hygiene tools. More specifically, the present invention relates to toothbrush assemblies and configurations incorporating a passive floss-threading structure that provides a single-point anchor for dental floss. The present invention is structurally distinguished from designs that incorporate internal floss spools or dispensers, forked or dual-arm floss supports, or mechanical tensioning frames configured to hold a span of floss between spaced-apart members.

### BACKGROUND OF THE INVENTION

Maintaining good oral hygiene generally requires both brushing and flossing. A toothbrush is effective for cleaning the outer surfaces of the teeth, while flossing is important for removing food particles and plaque from between the teeth. However, many users find it difficult to handle separate floss picks or strands, especially when trying to clean the back molars. Additionally, disposable floss picks create a lot of plastic waste and can be challenging for users with limited dexterity.

Although some solutions have been developed to simplify flossing—such as floss picks and flossers that are designed to fit on fingers—these products still require users to carry an extra tool and are often discarded after just one use. Thus, there is a need for an integrated solution that combines both brushing and flossing in a single tool. This device should be easy to use, reduce waste, and enable users to reach their back teeth without needing to put their fingers in their mouths.

Existing combination brushing and flossing devices typically rely on structural architectures that differ fundamentally from the present invention, such as dual-arm or forked supports that hold a span of floss under tension between spaced-apart members, internal floss storage cartridges or spools integrated into the handle, and mechanical tensioning or advancement systems for the floss.

In contrast, the disclosed toothbrush assembly employs a single floss-threading anchor location on the toothbrush that cooperates with floss supplied from an external source and tensioned manually by the user, without dual-arm supports, internal floss storage, or mechanical tensioning mechanisms.

The disclosed toothbrush assembly (“Floss Tool”) is designed to meet these needs by combining the functions of both brushing and flossing into one device. This innovative tool provides users with a more efficient and user-friendly way to take care of their dental hygiene, making it easier to stick to good oral care habits. By simplifying the daily routine of oral care, the Floss Tool aims to enhance the benefits of proper flossing, ultimately leading to better overall dental health and less reliance on separate, single-use dental products.

The present invention is intended to solve the problems associated with conventional devices and methods and provide improvements on these devices.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter’s scope.

The present invention pertains to an innovative toothbrush assembly that integrates a traditional toothbrush with a built-in floss-threading mechanism.

In all embodiments, the floss-threading feature on the toothbrush defines a single anchoring location for one end of a length of dental floss, while the opposing end of the floss is held manually by the user. The dental floss is not stretched or supported between two spaced-apart support members on the toothbrush, and is instead supplied from an external floss source rather than from any internal spool, cartridge, or dispenser within the toothbrush assembly.

This device incorporates a series of versatile floss-threading options that are strategically located on the toothbrush's handle and head, thus allowing for effective utilization of dental floss during brushing sessions.

The present invention features multiple threading configurations, which include apertures, hooks, and slits, that can accommodate various user preferences for securing the dental floss, enhancing convenience and adaptability for users.

Furthermore, this toothbrush assembly implements a simplified storage solution for dental floss that utilizes passive features for floss retention. This design eliminates the need for complex dispensers or built-in spools, enabling users to easily thread and manipulate the floss sourced from any standard floss package held by the user. The ergonomic design of the toothbrush assembly ensures ease of use and comfort, allowing users to hold the toothbrush securely while manipulating the floss to effectively clean interproximal spaces with minimal difficulty.

Importantly, the present invention is compatible with both manual and powered toothbrushes of varying shapes and sizes, which enables its adaptation to existing toothbrush models and minimizes the need for entirely new designs.

Additionally, the toothbrush assembly can accommodate dental floss made from various materials, including nylon, PTFE, or silk, and may be constructed from plastic, bioplastic, or other suitable hygienic materials, thereby ensuring its usability for a wide demographic, including both children and adults.

By integrating a flossing tool directly into the toothbrush, the present invention streamlines the oral hygiene process, reduces environmental waste, and encourages compliance with recommended flossing practices, ultimately contributing to enhanced overall dental health.

### BRIEF DESCRIPTION OF THE DRAWINGS

FIG. 1 is an illustration of one embodiment of the present invention, showing a toothbrush handle equipped with a floss-threading feature.

FIG. 2 is an illustration of another embodiment of the present invention, depicting the floss-threading feature positioned at the toothbrush head.

FIG. 3 illustrates several variations of the placement for the floss-threading features on the toothbrush head.

FIG. 4 is an illustration demonstrating the use of the floss-threading feature to clean between a user’s teeth.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of the best mode contemplated for carrying out the embodiments of the present disclosure. Other embodiments may also be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to the Floss Tool, an innovative toothbrush assembly that integrates a floss-threading mechanism into a single device, it is to be understood that this disclosure is illustrative and exemplary of the present disclosure, and is made merely for the purposes of providing a full and enabling disclosure. The detailed disclosure herein of one or more embodiments, including the construction of the elongated handle and the bristle head equipped with varied floss-threading structures, is not intended, nor is to be construed, to limit the scope of patent protection afforded in any claim of a patent issuing herefrom, which scope is to be defined by the claims and the equivalents thereof. It is not intended that the scope of patent protection be defined by reading into any claim limitation found herein and/or issuing herefrom that does not explicitly appear in the claim itself.

Thus, for example, any sequence(s) and/or temporal order of steps of various processes or methods that are described herein, such as the use of the floss-threading mechanism to facilitate dental hygiene through both brushing and flossing, are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing herefrom. The present disclosure contains headers. It should be understood that these headers are used as references and are not to be construed as limiting upon the subject matter disclosed under the header.

The present disclosure includes many aspects and features. Moreover, while many aspects and features relate to, and are described in the context of methods, systems, apparatuses, and devices for enhancing oral hygiene through a multifunctional toothbrush assembly that integrates a floss-threading mechanism for simultaneous brushing and flossing, embodiments of the present disclosure are not limited to use only in this context.

As used herein, the term “Floss Tool” is a non-limiting designation referring to a toothbrush assembly incorporating a floss-threading structure, and is not intended to imply a separate flossing device, a particular structure, or a limitation on configuration, materials, or use.

### Component List

10 - Floss: A length of dental floss configured for use with the disclosed toothbrush assembly.

20 - Handle: An ergonomically designed handle that provides a comfortable grip while allowing users to maneuver the toothbrush with ease.

30 - Toothbrush Head (Optional): A removable or integrated component featuring bristles for effective cleaning of teeth. Its inclusion enhances the multifunctional nature of the Floss Tool toothbrush assembly.

40a - Hole for Threading Floss: An access point integrated into the structure of the toothbrush head, facilitating easy threading of the floss for user convenience.

40b - Slit Option for Threading Floss: An alternative pathway within the toothbrush head that accommodates flossing methods, providing additional options for users.

40c - Hook Option for Threading Floss: A strategically placed hook designed to securely anchor the floss during use, enhancing the effectiveness of the floss-threading mechanism.

40 – Floss-threading structure: A structural feature such as a hole, slit, or hook configured to receive and retain dental floss.

The present invention 100 relates to a novel toothbrush assembly, designated as the Floss Tool, which integrates a multifunctional floss-threading mechanism into a single toothbrush assembly configuration.

This design effectively overcomes the deficiencies observed in traditional oral hygiene implements by amalgamating brushing and flossing capabilities within a unified structure, thereby facilitating improved user compliance with recommended dental care protocols.

The Floss Tool features an elongated handle 20 characterized by a proximal end and a distal end, at which a toothbrush head 30 is affixed and equipped with bristles for efficient brushing. The assembly incorporates at least one floss-threading structure selected from a group that includes a through-aperture 40a, a slit 40b, and a hook 40c.

As used herein, the term “floss-threading structure” 40 refers to any passive structural feature formed on or attached to the toothbrush handle 20 or head 30 that is configured to receive and retain an end of a length of dental floss at a single location on the toothbrush, including, without limitation, a hole 40a, slit 40b, hook 40c, slot 40d, peg 40e, loop 40f, or a functional equivalent thereof. In certain embodiments, the floss-threading structure 40 is a passive anchor that does not include an internal floss spool, floss dispenser, floss cutter, tensioning mechanism, or a forked floss-holding frame configured to support floss between spaced-apart arms.

This floss-threading structure can be integrally formed on either the handle or the head of the toothbrush, establishing a singular anchor point specifically designed to receive and secure one end of a strand of dental floss. This configuration enables the user to maintain grip on the opposing end of the floss during the flossing process.

In this innovative arrangement, the floss-threading mechanism is engineered to provide ease of access and user adaptability, thus optimizing the overall efficacy of the flossing operation while enhancing ergonomic engagement with the toothbrush's added functionalities.

### Toothbrush Body

The Floss Tool's toothbrush body 20 is constructed from durable materials that are safe for dental use, including FDA-approved plastics, bioplastics, and other biodegradable materials suitable for oral hygiene applications. This construction ensures that the Floss Tool maintains structural integrity and complies with health and safety standards.

### Integrated Floss Threading Mechanism

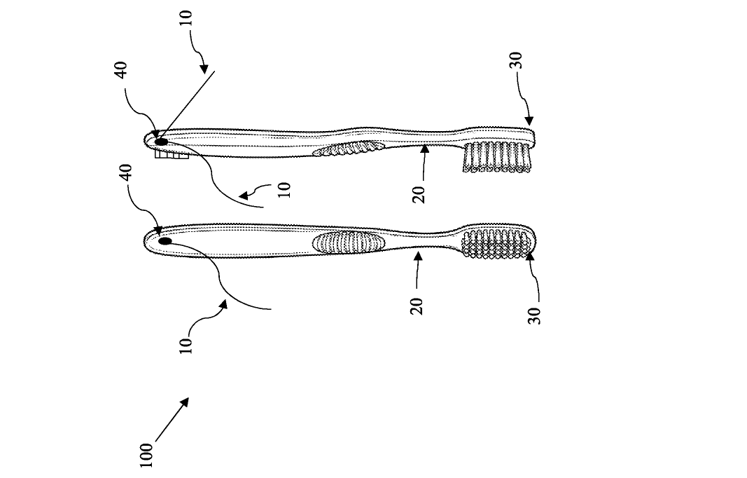

In one embodiment, illustrated in FIG. 1, the Floss Tool incorporates a floss-threading mechanism comprising multiple structural options, including holes 40, slits 40, and hooks 40. These threading structures can be located on either the handle or the head of the toothbrush. For instance, a circular through-aperture 40 may be integrally formed adjacent to the distal end of the handle, accommodating conventional dental floss and facilitating the anchoring of the floss to the toothbrush. Additionally, the elongated slit 40 may be engineered into the handle or head, allowing the user to press the floss laterally into the slot for a friction fit.

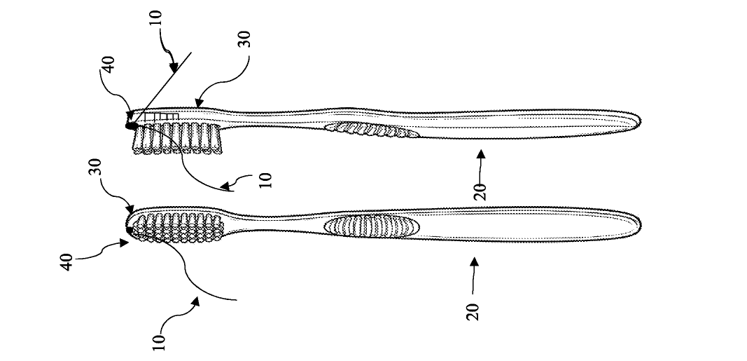

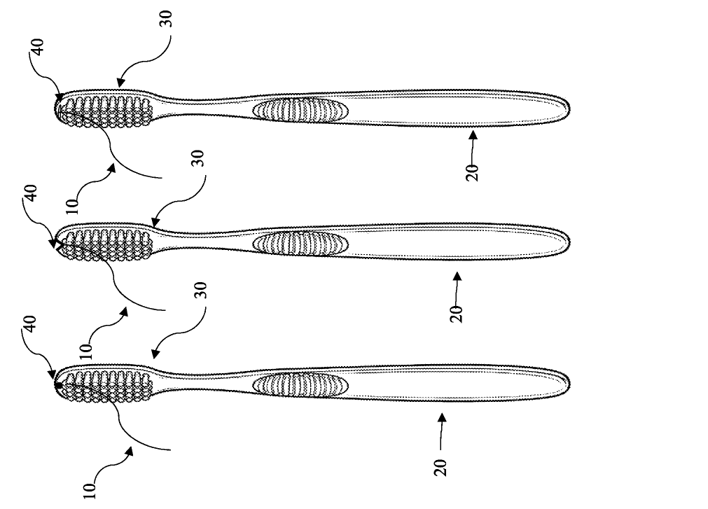

Moreover, the hook 40, which may project from the handle or head, serves as another versatile option for securing the dental floss. The floss-threading structure may also be positioned on the head 30 adjacent to the bristles, as illustrated in FIG. 2, enabling users to maintain the traditional orientation of the toothbrush while flossing without the need for inverting the tool. Further, FIG. 3 provides examples of various configurations, where the floss-threading structures may comprise a slit oriented transverse to the longitudinal axis of the handle or a hole extending through the head to accommodate user preferences.

### Functional Enhancements and Adaptability

The Floss Tool is devoid of any internal floss spool, dispenser, tensioning mechanism, or replaceable floss cartridge. This design ensures that dental floss is supplied from an external source, permitting users to select their preferred floss material, including nylon, PTFE, silk, biodegradable polymers, or other equivalent materials, which ensures optimal functionality.

Furthermore, the toothbrush assembly may include multiple floss-threading structures provided at distinct locations on the handle 20 and bristle head 30, each defining a single anchor point for dental floss.

In use, only one floss-threading structure 40 serves as an anchor point at a time, and the dental floss is not extended, tensioned, or otherwise supported between two or more floss-threading structures on the toothbrush.

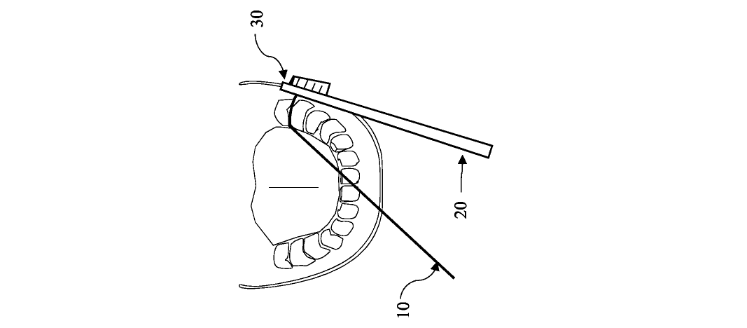

In this configuration, illustrated in FIG. 4, user preference and flexibility are maintained without the threads crossing over each other. In certain embodiments, multiple threading features can be integrally molded into either the handle or head during manufacturing or can be formed separately and affixed by adhesives, fasteners, or over-molding.

The floss-threading structure 40 may be incorporated into otherwise conventional manual or powered toothbrush designs with minimal modification to existing molds, tooling, or motor assemblies.

In some embodiments, existing toothbrush platforms are adapted simply by adding or revising a localized feature of the handle 20 or head 30 to form the floss-threading structure 40, without altering the basic handle geometry, bristle configuration, or, in the case of powered toothbrushes, the drive motor or transmission components.

The design of the Floss Tool allows for easy manipulation of both the bristles and the floss-threading structures, promoting effective engagement with all tooth surfaces, especially those that are difficult to reach, thereby enhancing overall oral hygiene practices.

### User Instructions and Ergonomics

The present invention includes clear, concise user instructions printed directly on the toothbrush body 20, supported by visual aids such as icons or diagrams. These instructions guide the user through the steps of obtaining a length of dental floss from an external source and anchoring one end of the floss to a floss-threading structure while holding the second end with the user's hand. This method allows the floss to extend away from the toothbrush, facilitating effective cleaning.

Users can insert the tensioned portion of the floss between adjacent teeth and move it back and forth to remove plaque and debris, optionally brushing their teeth with the bristles while the floss remains anchored to the toothbrush. This approach enhances the overall cleaning effect. Additionally, the design accommodates the user’s hand position, allowing for effective manipulation of the floss without obstruction from the head 30 of the toothbrush.

Although the invention has been explained in relation to its preferred embodiment, it is to be understood that many other possible modifications and variations can be made without departing from the spirit and scope of the invention.

What is claimed is:

1. A toothbrush assembly comprising:
an elongated handle having a proximal end and a distal end.
a head at the proximal end, the head carrying bristles for brushing; and
at least one floss-threading structure selected from the group consisting of a through-aperture, a slit, a hook, a loop, a peg, and a slot, wherein the floss-threading structure is formed on the handle or the head; wherein the floss-threading structure defines a single anchor point on the toothbrush that is sized and shaped to receive and secure one end of a strand of dental floss, the opposite end of the floss being held by a user during flossing;
wherein the strand of dental floss extends away from the toothbrush and is not stretched between two spaced-apart support members or prongs on the toothbrush;
wherein the toothbrush is devoid of any internal floss spool, dispenser, tensioning mechanism, or replaceable floss cartridge, such that dental floss is supplied from an external source;
whereby the toothbrush serves both as a brushing instrument and as a support for dental floss without incorporating previously patented floss dispensers or forked floss holders.

2. The toothbrush assembly of claim 1, wherein the floss-threading structure comprises a circular through-aperture adjacent the distal end of the handle.

3. The toothbrush assembly of claim 1, wherein the floss-threading structure comprises an elongated slit cut into the handle.

4. The toothbrush assembly of claim 1, wherein the floss-threading structure comprises a hook or peg projecting from the handle.

5. The toothbrush assembly of claim 1, wherein the floss-threading structure is located on the head adjacent to the bristles.

6. The toothbrush assembly of claim 5, wherein the floss-threading structure comprises a slit oriented transverse to the longitudinal axis of the handle.

7. The toothbrush assembly of claim 5, wherein the floss-threading structure comprises a hole extending through the head.

8. The toothbrush assembly of claim 1, wherein the head is part of a powered toothbrush and includes a floss-threading structure that does not interfere with the operation of the motor.

9. The toothbrush assembly of claim 1, wherein the floss-threading structure includes a protective cover or gate that closes over the structure when not in use.

10. The toothbrush assembly of claim 1, wherein the characteristics of the floss-threading structure are sized to accommodate dental floss made from various materials while ensuring optimal functionality.

11. A toothbrush assembly comprising:
a toothbrush body having an elongated handle and a bristle head; and
multiple floss-threading structure provided at different locations on the
handle and the bristle head, each structure defining a single anchor point
for dental floss without crossing over any other structure,
wherein the multiple floss-threading structures include at least one
structure on both the handle and the head to accommodate user
preferences.

12. The toothbrush assembly of claim 11, wherein the floss-threading structures are integrally molded into the handle or head during manufacture.

13. The toothbrush assembly of claim 11, wherein the floss-threading structures are formed separately and affixed to the handle or head by adhesive, fasteners, or over-molding.

14. The toothbrush assembly of claim 11, wherein the toothbrush body is constructed from materials suitable for oral hygiene, including plastic, bioplastic, bamboo, or other biodegradable materials.

15. The toothbrush assembly of claim 11, wherein the toothbrush body is designed to allow for easy manipulation of both the bristles and the floss-threading structures without hindrance.

16. A method comprising the steps of:
obtaining a length of dental floss from an external source;
anchoring a first end of the dental floss to a floss-threading structure;
inserting the tensioned portion of the floss between adjacent teeth and moving it back and forth to remove plaque and debris; and
optionally brushing the teeth with the bristles while the floss remains anchored to the toothbrush;
wherein the toothbrush lacks any internal floss spool or dispenser and relies on the external floss source.

17. The method of claim 16, wherein the dental floss is anchored to the floss-threading structure by any method of engagement including looping, tying, frictional insertion, wrapping, or other equivalent securing means.

18. The method of claim 16, wherein the user’s hand position allows for effective manipulation of the floss without obstruction from the head of the toothbrush.

19. The method of claim 16, wherein the brushing step is performed simultaneously with flossing to enhance the overall cleaning effect.

20. The method of claim 16, further comprising the step of selecting dental floss made from nylon, PTFE, silk, biodegradable polymer, or other floss materials.
